(19) United States
(12) Patent Application Publication
(10) Pub. No.: US 2021/0090067 A1
(43) Pub. Date: Mar. 25, 2021

(54) OFFLINE PROXIMITY RIDESHARE BOOKING SYSTEM

(71) Applicant: Ford Global Technologies, LLC, Dearborn, MI (US)

(72) Inventors: Romil Shah, Santa Clara, CA (US); Anuja Shirsat, Mountain View, CA (US); Matthew Mckenzie, Detroit, MI (US); Vidhya Iyer, Sunnyvale, CA (US)

(73) Assignee: Ford Global Technologies, LLC, Dearborn, MI (US)

(21) Appl. No.: 16/581,104

(22) Filed: Sep. 24, 2019

(51) Int. Cl. G06Q 20/32; G06Q 50/30; H04W 12/00; H04W 4/80

(52) U.S. Cl. CPC G06Q 20/3278; G06Q 20/3224; H04W 4/80; H04W 12/003; G06Q 50/30

(57) ABSTRACT

Embodiments described herein are directed to locating the position of a mobile device without an Internet or Global Positioning Service (GPS) connection using a rideshare application that utilizes multiple low-energy communication signals from nearby devices to triangulate position. A first device seeking a rideshare arrangement transmits a low-energy signal as a beacon probe. A rideshare application running on the first device determines a relative position of the first device with respect to two or more other devices using signal triangulation methods. One of the cooperating devices encodes an encrypted communication channel and establishes an encrypted link with at least the first device. The connected devices share user identification information, and the first device transmits payment information to one of the two or more devices for online or offline payment of the rideshare.

### TECHNICAL FIELD

The present disclosure relates to device location and triangulation and more particularly to generation of a crowdsourced low-energy beacon network that enables offline location of a requesting device using signal triangulation.

### BACKGROUND

Booking transportation using a ridesharing service often requires Internet connectivity to communicate with the ridesharing platform using an application or browser on the mobile device. In some environments (e.g., a city with high-rise buildings, or other signal-blocking features), inconsistent internet connectivity is not uncommon. Moreover, areas with poor or no Internet connectivity often have challenges with GPS signal transmission, making GPS an unreliable resource for locating the rider. Conventional systems may allow rideshare booking using short message services (SMS), but not without an Internet connection.

A method for ordering a transportation vehicle using Near Field Communication (NFC) is disclosed in European Patent Publication No. 2879410 (“the '410 publication”), which describes a method for requesting a rideshare vehicle using NFC location services. While the system described in the '410 publication may overcome the problem of device-to-device communication without Internet connectivity, it does not disclose signal triangulation for spatial location of the requesting device using Bluetooth® or Wi-Fi communication protocols.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative operating environment in which techniques and embodiments disclosed herein may be implemented.

FIG. 2 depicts a functional schematic and computing architecture of devices used in accordance with the present disclosure.

FIG. 3 depicts a rideshare user broadcasting a beacon probe request while using the rideshare application in accordance with the present disclosure.

FIG. 4 is a graphical representation of devices forming a network for low-energy signal triangulation in accordance with the present disclosure.

FIG. 5 is a flowchart of an example method for low-energy signal triangulation using mobile devices in accordance with the present disclosure.

### DETAILED DESCRIPTION

### Overview

The systems and methods disclosed herein may utilize a mobile device application operating on three or more participating devices, all concurrently within an immediate physical proximity, that together form a beacon network that locates a user of one of the three or more participating devices requesting pickup by a ridesharing driver. The participating devices can locate the requesting user using the Bluetooth® or Wi-Fi hotspot functionality on their devices without having access to the Internet, and without a GPS signal. Devices running the ridesharing application can cooperate to create the beacon network, where the precision of the beacon network location services increases with the addition of cooperating devices within immediate proximity from one another.

The cooperating devices may be described in terms of devices used by drivers of the ridesharing application (driver nodes) and passengers using the ridesharing application (rider nodes). Driver nodes may be devices used by drivers currently operating a rideshare vehicle while having the application executing on their mobile device. Rider nodes may have the application running on their device and be requesting pickup from either a stationary building location or from a moving location while the rider is perambulating, or the rider node may be perambulating on foot in the immediate area and although not requesting pickup, have the application running on their device. Rider nodes may also refer to devices used by rideshare customers (riders) that have the application running on their devices while in transit in the immediate area. In some instances, the rider nodes may be outside of vehicles but in proximity to other users. In other instances, rider nodes may be inside of a rideshare vehicle as a passenger.

Instead of finding rideshare vehicles through the Internet, personal hotspot and Bluetooth® functionalities operating on rider nodes and driver nodes may provide location services by triangulating the position of a requesting rider node. Any triangulation operation requires at least three devices, with at least one of the three devices being a driver node. The driver nodes (which may be automobile computing systems onboard the vehicles, or another computing device such as the driver's smartphone) can function as Bluetooth® or Wi-Fi beacons that use the device signal strength to positionally locate a person within limited ranges of distance. In one embodiment, they may locate requesting devices when they are up to 30 feet or less in distance from at least three participating devices.

The driver node establishes a secure communication channel by assigning a Wi-Fi hotspot or Bluetooth® encoding through their vehicle communication system or the driver node device. An application on the driver node establishes a secure channel with the rider node(s) with encoding provided through the rideshare application on the driver node device for the purpose of (1) determining a rider's unique identification, (2) determining the rider's location coordinates if they are available, and (3) evaluating a rider's signal strength to identify approximate distance from the driver node. The driver node device may establish a secured encoding to enable authorized payments for the rideshare. The secured encoding is uniquely mapped to an identification of a requesting rider associated with the rider node or an identification of a driver associated with a driver node.

Embodiments of the present disclosure allow ridesharing users to positionally locate one another without Internet or GPS connections, and securely pass electronic identification credentials to each other on the user's own behalf or on behalf of other verified users to pay for rideshare rides. The cooperating devices may trade payment information for the transportation services over secure offline channels, where the transportation transaction is settled immediately in fixed amounts that can be paid by the rider through offline payment modes. For example, when one or more of the devices lack Internet connectivity, rider nodes may settle payment using blockchain-based secure token transfer, which can be redeemed by the recipient driver when later connected with a network. In other aspects, the creation of secure channels may allow immediate offline payment using the blockchain secure encoding associated with digital currencies like Bitcoin, Ethereum, or other similar technologies.

These and other advantages of the present disclosure are provided in greater detail herein.

### Illustrative Embodiments

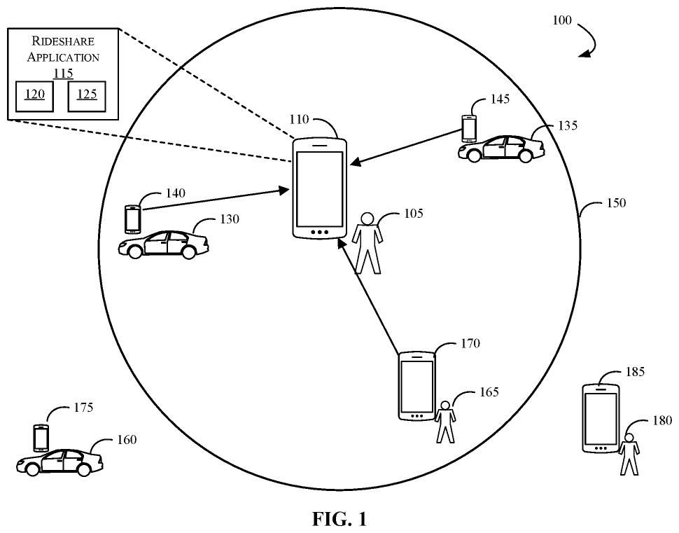

FIG. 1 depicts an illustrative operating environment 100 for implementing an offline rideshare booking system, according to embodiments of the present disclosure. In some example embodiments, the operating environment 100 may be an area with limited or no Internet connectivity, such as a densely populated city with high rise buildings or other features that may block transmission of signals. It may not be uncommon for network signals such as the Internet and GPS to become weak and unusable in such environments. Referring first to FIG. 1, a rideshare user 105 is illustrated with a mobile device 110. The mobile device 110 includes a rideshare application 115 that may either be enabled (running) or disabled (not running or not installed). When the rideshare application 115 is running, a node triangulation engine 120 and a channel encryption engine 125, which may be included as part of the rideshare application 115, may provide location services that assist drivers to locate the rider node device 110. Hereafter, a device having an enabled rideshare application (e.g., the rideshare application 115) may be referred to collectively as a node. The mobile device 110 is running a copy of the rideshare application 115, and thus, is referred to hereafter as a “rider node 110.”

Various other users of the rideshare application 115 may be dispersed throughout the operating environment 100, including a rideshare driver 130, who may operate a mobile device 140 and an enabled copy of the rideshare application, and a rideshare driver 135 who may operate a mobile device 145 having an enabled copy of the rideshare application. The mobile device 140 and the rideshare application running on that device 140 are collectively referred to hereafter as “the driver node 140.” The mobile device 145 and the rideshare application running on that device 145 are collectively referred to hereafter as “the driver node 145.” The rideshare application is operative as part of the driver node 140 and the driver node 145, and may be substantially similar to or identical to the rideshare application 115 operative as the rider node 110. Another rideshare customer 165, who may be standing nearby, for example, may use a mobile device 170 and an enabled copy of the rideshare application. The mobile device 170 and the rideshare application running on that mobile device 170 are collectively referred to hereafter as “the rider node 170.”

A third rideshare driver 160 may also run a local copy of the rideshare application on a mobile device 175. The mobile device 175, although running the rideshare application, may not be considered a node because they are outside of the operating range 150 of the rider node 110. Similarly, a rideshare customer 180 may use a mobile device 185 enabled with a copy of the rideshare application but may not be a node because the device is out of the operating range. As used herein, an “enabled copy” of the rideshare application is an instantiation of the rideshare application that is executing on the mobile device. A device having a copy of the application but not executing the application is said to have a “disabled copy” of the application. For example, the app may simply be closed.

In an example embodiment, the rideshare user 105 may indicate in the rideshare application 115 that they would like to book transportation services with a rideshare driver in the area. Because the Internet and/or GPS may not reliably function in the example operating environment 100, the rider node 110 may transmit a low-energy signal using one or more protocols such as, for example, a Bluetooth® signal protocol, a Bluetooth Low Energy® signal protocol, or a Wi-Fi signal protocol. The rideshare application 115 may cause the rider node 110 to transmit a low-energy signal such as Bluetooth or as a Wi-Fi signal. Accordingly, the rider node 110 may enable the mobile device 110 to act as a Wi-Fi hotspot, and/or broadcast the beacon signal using the Bluetooth® protocol stack. Bluetooth® is a proprietary open wireless technology standard for exchanging data over short distances (using short-wavelength radio transmissions in the Industrial, Scientific, and Medical (ISM) radio bands from 2400-2480 MHz) from fixed and mobile devices, and generally works by creating security-enabled personal area networks (PANs). Low-energy signals may have a limited range of distance over which the signal may be usable by another device. An operating range 150 depicted in FIG. 1 as a circle, depicts an example range for low-energy signal transmission. In some example embodiments, the range may be 10-30 feet, for example.

In one aspect, the mobile device 110 may encode the low-energy signal as a beacon probe request and broadcast the low-energy signal using a transceiver onboard the rider node 110. The beacon probe may be uniquely associated with the rideshare application 115 and may transmit information uniquely identifying the rideshare user 105. For example, the beacon probe request may transmit one or more of the rideshare user's unique identification (ID) associated with the rideshare application 115, and if available, coordinates of the rideshare user's location, which may include GPS or other coordinates. When three responsive signals are received from at least the driver node 140, the driver node 145 and the rider node 170, respectively, the rider node 110 may determine a signal strength associated with each respective signal response. Signal strength information may be included in the beacon probe response signal sent from the responding devices. In other aspects, the device may determine signal strength by direct measurement, such as by measuring a Received Signal Strength Indicator (RSSI) or other measurements known in the art.

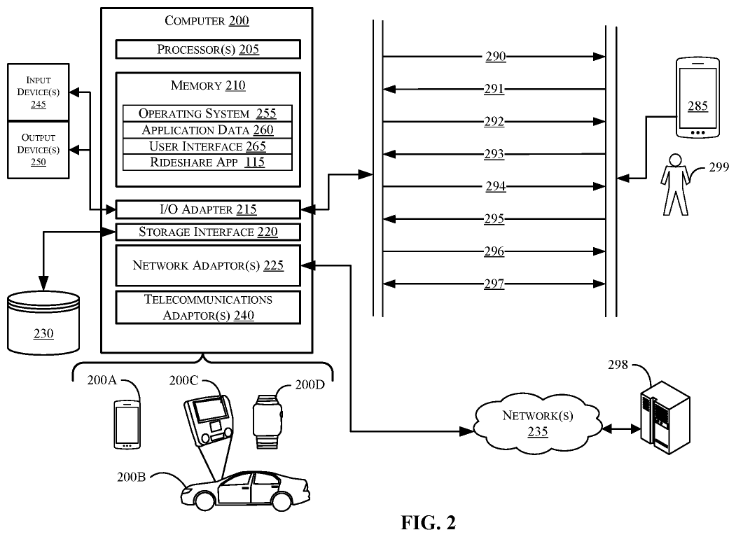

FIG. 2 illustrates a block diagram of an exemplary computing architecture and computer 200 for use in practicing the embodiments described herein. The environment and system described herein can be implemented in hardware, software (e.g., firmware), or a combination thereof. The computer 200 may be implemented in a smartphone 200A, a vehicle 200B, and/or a telematics system 200C or other type of in-vehicle computer. The computer 200 may further be implemented as a smart watch 200D or other wearable device configured for embodiments of the present disclosure.

Additionally, the computer 200 may be implemented in a device that is separate from but communicatively coupled to one or more vehicle telematic devices such as the telematics system 200C located in the vehicle 200B. Some examples of the telematics system 200C can include an infotainment system mounted on a dashboard of the vehicle 200B, a radio communications device mounted in the vehicle 200B, a personal device such as a smartphone carried by the driver or another occupant of the vehicle 200B, a computer installed in the vehicle 200B, and/or a portable computing device such as a tablet computer (not shown in FIG. 2).

Regardless of the mode of implementation, the computer 200 may include the one or more processor(s) 205, a memory 210 communicatively coupled to the one or more processor(s) 205, and one or more input/output adapters 215 that can communicatively connect with external devices. The computer 200 may operatively connect to and communicate information with one or more internal and/or external memory devices such as, for example, one or more external database(s) 230 via a storage interface 220. The computer 200 may include one or more network adapter(s) 225 enabled to communicatively connect the computer 200 with one or more network(s) 235. In some example embodiments, the network(s) 235 may be or include a telecommunications network infrastructure. In such embodiments, the computer 200 can further include one or more telecommunications adaptor(s) 240. The computer 200 may further include and/or connect with one or more input devices 245 and/or one or more output device(s) 250 through the I/O adapter(s) 215.

The one or more processor(s) 205 collectively operate as a hardware device for executing program instructions (aka software), stored in a computer-readable memory (e.g., the memory 210). The one or more processor(s) 205 can be a custom made or commercially-available processor, a central processing unit (CPU), a plurality of CPUs, an auxiliary processor among several other processors associated with the computer 200, a semiconductor based microprocessor (in the form of a microchip or chip set), or generally any device for executing instructions.

The one or more processor(s) 205 may be disposed in communication with one or more memory devices (e.g., the memory 210 and/or one or more external database(s) 230, etc.) via a storage interface 220. For example, when the computer 200 is in a location having Internet or other network access, the processor(s) 205 may access the external database(s) 230 to communicate rideshare application user credentials, payment information, blockchain transaction information, etc.

The storage interface 220 can also connect to one or more memory devices including, without limitation, one or more external databases 230, and/or one or more other memory drives (not shown in FIG. 2) including, for example, a removable disc drive, a vehicle computing system memory, cloud storage, etc., employing connection protocols such as serial advanced technology attachment (SATA), integrated drive electronics (IDE), IEEE-1394, universal serial bus (USB), fiber channel, small computer systems interface (SCSI), etc.

The memory 210 can include random access memory (RAM) such as, for example, Dynamic Random Access Memory (DRAM), Static Random Access Memory (SRAM), Synchronous Dynamic Random Access Memory (SDRAM), etc., and read only memory (ROM) that may include any one or more nonvolatile memory elements (e.g., erasable programmable read only memory (EPROM), flash memory, electronically erasable programmable read only memory (EEPROM), programmable read only memory (PROM), etc. Moreover, the memory 210 can incorporate electronic, magnetic, optical, and/or other types of non-transitory computer-readable storage media. In some example embodiments, the memory 210 may also function as part of a distributed architecture, where various components are physically situated remote from one another, but can be accessed by the one or more processor(s) 205.

The instructions in the memory 210 can include one or more separate programs, each of which can include an ordered listing of computer-executable instructions for implementing logical functions. In the example of FIG. 2, the instructions in the memory 210 can include an operating system 255. The operating system 255 can control the execution of other computer programs such as, for example a rideshare application 115, and provide scheduling, input-output control, file and data management, memory management, and communication control and related services. In one embodiment, the operating system 255 may instruct the processor(s) 205 to retrieve signal power information (also referred to herein as “signal energy”) associated with one or more probe response signals received by the network adaptor(s) 225 and/or the telecommunications adaptor(s) 240, to save one or more values associated with the signal energy to particular memory locations in the memory 210, and map the memory locations to a lookup table (not shown in FIG. 2) operative by a triangulation engine associated with the rideshare application 115. The triangulation engine may include one or more analytical models that receive signal strength measurements as inputs and output a predicted distance vector based on models known in the art.

The program instructions stored in the memory 210 can further include application data 260, and instructions for controlling and/or interacting with the computer through a user interface (e.g., the output device(s) 250). The application data 260 may include user profile information associated with the rideshare application 115, payment credentials such as passcode information, blockchain identification information, payment account data, profile information, etc.

The memory 210 can also include program instructions for the rideshare application 115 including, for example, the node triangulation engine 120 and the channel encryption engine 125 depicted with respect to FIG. 1. In some aspects, the rideshare application 115 may also control functionality of a low-energy signal transmitting device such as, for example, a Bluetooth® transmitter embodied as the I/O adapter 215 discussed hereafter. In some aspects, the instructions may cause the I/O adapter 215 to transmit a beacon signal configured as an inquiry packet 290. In other aspects the I/O adapter may function in an unconnected state (e.g., standby mode), and switch into an inquire mode at predetermined intervals to “listen” for broadcasting of low-energy signals associated with other users of the rideshare application 115. Rider nodes (e.g., the rider nodes 110 and 170 as shown in FIG. 1) and driver nodes (e.g., the driver nodes 140 and 145 as shown in FIG. 1) may also function as transmitting nodes such that any one of them may broadcast the beacon signal, or function as receiving nodes that receive the beacon signal and send response signals to establish secure channels. In the present example of FIG. 2, the computer 200 may run the rideshare application 115 and also function as the transmitting node to broadcast the beacon signal.

When operating as the transmitting node, the program instructions on the sending device (e.g., the computer 200) may cause the processor(s) 205 to transition between states of a protocol sequence for establishing the ad hoc network including, for example, broadcasting an inquiry packet configured as a beacon probe request using the transceiver, and transitioning into a page mode responsive to receiving one or more inquiry responses from the receiving device (described herein as “receiving node 285”). It should be appreciated that, because the computer 200 is broadcasting the inquiry packet to every device within range that is listening, the receiving node 285 is representative of any and all listening devices, which may be other driver nodes, and/or other rider nodes. The paging mode may be used to connect to devices whose addresses and approximate clock values may be known. For example, in one example embodiment the instructions may cause the processor(s) 205 to broadcast the inquiry packet 290 as a beacon probe request using the transceiver (e.g., the I/O adapter 215). The receiving node 285 may return an inquiry response 291 indicative of a device local name of the receiving node 285, a service class universally unique identifier (UUID) for services the device supports. The service class UUID is a value that identifies a type of service/functionality provided by the device receiving node 285. The inquiry response 291 may include transmission power, and other information. The transmission power may include, for example, a single byte value containing a transmission power level between −127 dBm and +127 dBm, and/or a Received Signal Strength Indicator (RSSI) to calculate path loss and give an estimate of which of two or more responding devices is physically closer to the inquiring device (e.g., the computer 200).

The processor(s) may transition into a connection state after sending a frequency hopping spectrum (FHS) packet 294 to the receiving node 285. In the connection state, the receiving node 285 may transmit at packet 295 unique identity information such as rider identity information and rider location information (if it is available) to the processor 205. The computer 200 via the processor 205 may then transmit back unique identification credentials 296 such as user identification, automobile information, and other identifying data.

In some aspects, responsive to receiving the inquiry response 291, the processor(s) 205 may register the response information in memory 210, and register one or more Media Access Control (MAC) addresses associated with the receiving node 285 in the memory 210. Processor(s) 205 may generate a paging reply 292 using the address from the inquiry response 291, and form a connection using pairing information 293, such as PIN code information received from the receiving node 285. For example, the computer 200 may receive, via the one or more encrypted communication channels established between the computer 200 and the receiving node 285, user identification information associated with one or more of the second device and a third device. The user identification information may identify a rideshare customer 299 associated with the rideshare application running on the receiving node 285. The user identification information may also include rideshare information associated with a third customer (not shown in FIG. 2), where the third customer participated via responding with a low-energy signal triangulation procedure (described hereafter).

The I/O adapter 215 can connect a plurality of input devices 245 to the computer 200. The input devices can include, for example, a keyboard, a mouse, a microphone, a sensor, etc. (not shown in FIG. 2). The output device(s) 250 can include, for example, a display, a speaker, a touchscreen, etc. (also not shown in FIG. 2).

The I/O adapter 215 can further include a display adapter coupled to one or more displays (not shown in FIG. 2). The I/O adapter 215 can be configured to operatively connect one or more input/output (I/O) devices 245, 250 to the computer 200. For example, the I/O adapter 215 can connect a keyboard and mouse, a touchscreen, a speaker, a haptic output device, or other output device such as the telematics system 200C, the smart watch 200D, another smartphone, etc. The output devices 250 can include but are not limited to a printer, a scanner, a shared screen on a connected device, etc. Other output devices can also be included, and are contemplated, although not shown in FIG. 2.

Finally, the I/O devices connectable to the I/O adapter 215 can further include devices that communicate both inputs and outputs, for instance but are not limited to, for example, a network interface card (NIC) or modulator/demodulator (for accessing other files, devices, systems, or a network), a radio frequency (RF) or other transceiver, a telephonic interface, a bridge, a router, and the like (not shown in FIG. 2). A Bluetooth® transmitter is such an example. It should be appreciated that embodiments of the present disclosure provide methods and devices that encode and transmit low-energy signals (e.g., a Bluetooth® protocol, a Wi-Fi protocol, etc.) to create ad hoc networks without accessing the Internet. For example, in one aspect, a rider or a driver in a rideshare scenario may broadcast a low-energy signal using an I/O adapter 215 to broadcast a beacon probe. The beacon probe transmitted as the low-energy signal may be associated with the rideshare application 115 (e.g., the rideshare application 115) executing on the sending device.

According to some example embodiments, the computer 200 can include a mobile telecommunications adapter 240. The mobile telecommunications adapter 240 can include a global positioning system (GPS), cellular, mobile, and/or other communications protocols for wireless communication. In some example embodiments, the GPS signal for a particular location may not be usable. In other aspects, a GPS signal may be receivable by a rider or driver node. In such cases, the respective node may transmit a set of GPS coordinates together with the inquiry response.

The one or more network(s) 235 can be or include an internet protocol (IP)-based network for communication between the computer 200 and any external device. The one or more network(s) 235 may transmit and receive data between the computer 200 and devices and/or systems external to the computer 200. In an exemplary embodiment, the one or more network(s) 235 can be a managed IP network administered by a service provider. The one or more network(s) 235 can be a network internal to a vehicle for a public carrier, such as a train, aircraft, bus, etc. For example, the network 235 may be an avionics network, or a vehicle-to-vehicle network. The one or more network(s) 235 can be implemented in a wireless fashion, e.g., using wireless protocols and technologies, such as Wi-Fi, Wi-Max, etc. The one or more network(s) 235 can also connect with and/or include a wired network, e.g., an Ethernet network, a controller area network (CAN), etc., having any wired connectivity. The one or more network(s) 235 can also be and/or include a packet-switched network such as a local area network, wide area network, metropolitan area network, the Internet, or other similar type of network environment. The one or more network(s) 235 can be a fixed wireless network, a wireless local area network (LAN), a wireless wide area network (WAN) a personal area network (PAN), a virtual private network (VPN), intranet or another suitable network system.

The one or more network(s) 235 can operatively connect the computer 200 to one or more devices including, for example, a server 298, which may coordinate various users associated with the rideshare application 115 such as the receiving node 285 and the computer 200, store payment information, user identification information, and other related data.

The rideshare application 115 may determine locations of requesting rideshare users (riders) using low-energy signal triangulation based at least in part on the signal energy associated with two or more responding signals. One such responding signal is the inquiry response 291 received from the receiving node 285. In low-energy signal triangulation, RSSI values may be used to calculate relative distances between devices, which may also be correlated to local maps, and/or used to generate other indications of location. Positioning systems may generate data to calculate a present location of a desired user using a time of arrival (TOA) calculation, a time difference of arrival (TDOA) calculation, and/or an angle of arrival (AOA) calculation. RSSI indicates a signal strength or power of the received signal. The strength of a signal may be obtained by determining a path loss value based at least in part on the RSSI values, and evaluating an inverse relationship between the path loss value and a square of the calculated distance. Other methods are possible and contemplated.

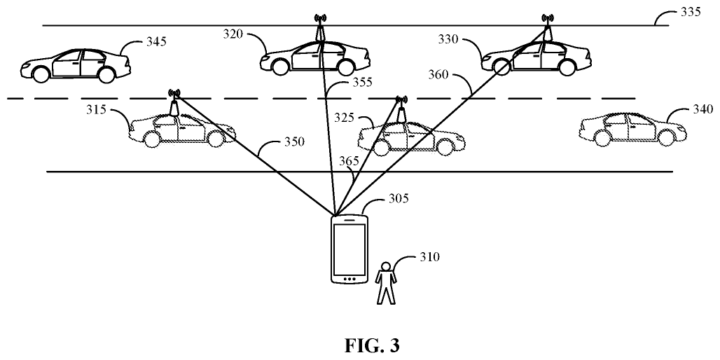

FIG. 3 depicts another example embodiment where a rider 310 broadcasts a low-energy signal 350, 355, and 360, from a rider node 305. The low-energy signal may include one or more protocol elements for establishing a beacon network, including, for example, a beacon probe request. The rider node 305 may be substantially similar or identical to the mobile devices/nodes 110, 140, 145, 170, 175, and 180 depicted in FIG. 1, or the computer 200, and/or receiving node 285 depicted with respect to FIGS. 2 and 3. The low-energy signals 350-360 may utilize one or more protocols such as a Bluetooth® protocol, a Wi-Fi protocol, an infrared (IR) wave, an ultrasonic wave, a wireless local area network (WLAN) hotspot signal, a radio frequency identification (RFID) technology, or a combination thereof. A plurality of driver nodes 315, 320, 325, and 330 may be associated with respective rideshare drivers that are driving on a road 335. The rider 310 may be in a position proximate the moving vehicles (e.g., within a 30-foot radius from at least some of the vehicles).

As depicted in FIG. 3, not every one of the vehicles on the road 335 may be considered nodes. Some drivers may not participate in the ridesharing platform, such as the unavailable driver 345. Yet others, such as the unavailable driver 340, may be out of range of the rider node 305. In one example, an operational range may be between 10 to 30 feet radially from the requesting device. Other ranges are contemplated, and may depend on transmission frequencies used, transmission energy, objects impeding line of sight, and transmission encodings that may dispose the rider node 305 for longer or shorter wavelength transmissions.

In the embodiment depicted in FIG. 3, the rider device (hereafter user node 305″) may be the transmitting device that broadcasts the beacon signal. The rider 310 may not be easily identified because the user may be in a crowd (not shown in FIG. 3 for clarity) such that it is not immediately obvious to a passing driver which person of the crowd is hailing a rideshare. The rider node 305 may receive one or more inquiry response signals (not shown in FIG. 3) responsive to the inquiry beacon probe request. The response signals may indicate signal strength such as, for example, RSSI. Other methods known for signal triangulation such as, for example, least square estimation, three border and centroid methods, among others, are contemplated.

In some aspects, the driver nodes 315, 320, 325, and 330 may receive an encoded message from the transmitting device (in this example, the rider node 305) that indicates which of the driver devices are closest to the rider 310. For example, the driver node 325 may be closest to the rider 310 when the beacon probe request is sent. Accordingly, the driver node 325 may transmit a response signal to the rider node 305 and any other of the listening devices (e.g., the driver nodes 315-330), where the response signal indicates a signal energy associated with the low-energy signal 365, and an indication that the driver node 325 has been assigned the task of locating the rider 310 and securing a secure channel with which payment information may be communicated from the rider node 305 to the driver node 325.

In some aspects, the driver node 325 may output an image on a user interface that identifies an approximate location of the rider 310 respective to the driver device 325. For example, the user interface (not shown in FIG. 3) may generate a locating arrow that points in a direction that changes in real time with respect to a forward direction of the driver device 325, where the arrow changes position to point toward the rider node 305. In another aspect, a tone may sound on the driver device that changes pitch as the driver device 325 closes the distance between itself and the requesting rider node 305. Other locating techniques are possible, and are contemplated.

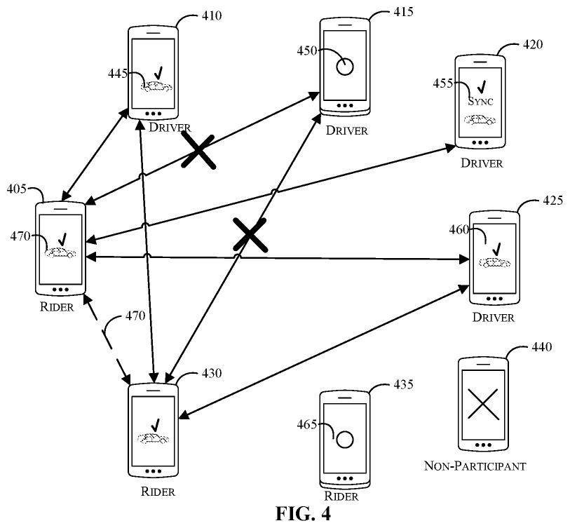

FIG. 4 is a graphical representation of distance triangulation of a device using a plurality of low energy signals transmitted from a plurality of devices in accordance with the present disclosure. The devices may be associated with drivers, riders, or non-participating devices. The non-participants (or more precisely, the devices associated with them) may not have a rideshare application installed on the device, may have a rideshare application installed on the device yet it is disabled, may not agree to accept rideshare signal transmissions, or may not participate for other reasons. In the example of FIG. 4, the participating devices are referred to as nodes, where a first rider node 405 may operate as a main node in an ad hoc network. A first rider node 405 may transmit a beacon probe request (depicted as solid arrows in FIG. 4) to all of the devices within operational distance, including a first driver node 410, a second driver device 415, a third driver node 420, and a fourth driver node 425. Two rider devices are depicted, including a second rider node 430, and a third rider device 435. A non-participating device 440 is shown, which may be a device within operational range of the first rider node 405, but without a rideshare application installed on their device (illustrated as an “X” on the user interface of the device). The first driver node 410 is depicted as having an active rideshare application 445 running on the device. The second driver device 415 may have the rideshare application loaded on the device, but may not be running the application, which is illustrated a disabled application 450. The third driver node 420 may have an active rideshare application running on their vehicle telematics system, as illustrated as the running application 455. In the present example, the driver node 420 is operating the rideshare application using an onboard vehicle telematics system. The fourth driver node 425 includes an enabled application 460. The third rider device 435 has a disabled application 465, making the third rider device 435 a non-participant (and thus, not a “node”).

As shown in FIG. 4, the first rider node 405 may provide location information to its location by transmitting GPS coordinates associated with the first rider node 405 if they are available, and/or transmitting a low-energy signal as a beacon probe request using an onboard transceiver (e.g., the I/O adapter 215 as shown in FIG. 2). The second rider node 430 may also transmit a low-energy signal as a beacon probe request or transmit GPS coordinates associated with the second rider node 430 (if available). It should be appreciated that one aim of the present disclosure is to positionally locate participating devices (in this example, the first rider node 405 and the second rider node 430) with respect to the available driver nodes 410, 420 and 425.

Location position services using signal triangulation requires at least three participating nodes. For example, the first rider node 405 may not use the second driver device 415 for signal triangulation because that driver node has a disabled application 450, which prevents the signal transmission procedures described herein. Similarly, the second driver node may not be of any assistance to the second rider node 430 for the same reason. The first driver node 410 may respond with a response signal, which may include a value indicative of a signal energy. In other aspects, the receiving device receives the signal and performs an analysis of the signal energy. The signal energy, as described above, may be used to determine a relative position when evaluated in conjunction with the observed signal energy of at least two other signals. A second responding device, the third driver node 420, may respond with a second response signal. The signal energy of the second response signal, when evaluated in conjunction with the signal energy of two other signals, may provide an estimation of a position of the requesting device with respect to the other responding nodes.

In another aspect, the second rider node 430 may be positionally located using signal responses from one or more of the first driver node 410, and/or the fourth driver node 425. In other aspects, as depicted with a dashed arrow, the rider nodes 405 and 430 may agree to cooperate together by a conditional sharing agreement 470, which allows secure information sharing between the devices, such as, for example, a respective location, user identification, signal transmission strength, or other information associated with any of the connected nodes (and their respective users).

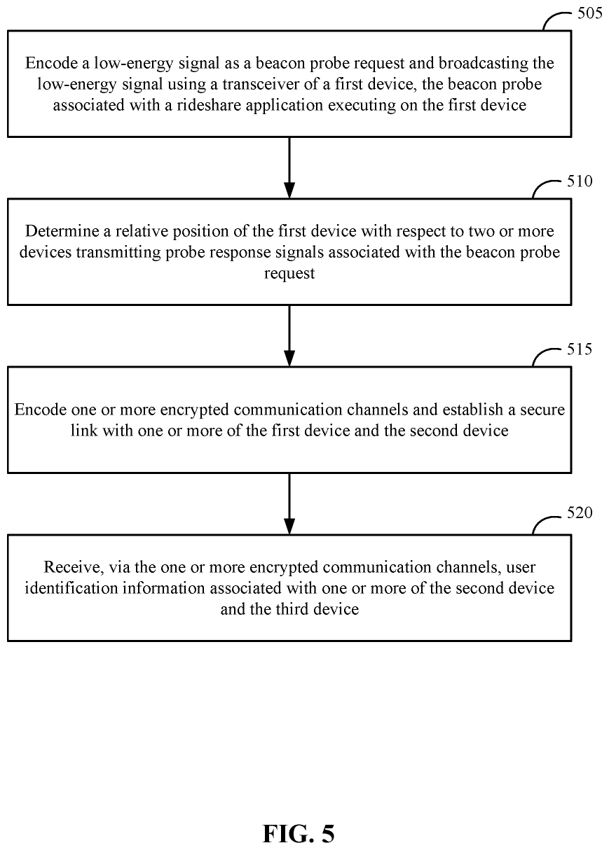

FIG. 5 is a flowchart of an example method low-energy signal triangulation using mobile devices in accordance with the present disclosure. In an initial step 505, a device processor, such as, for example, the one or more processor(s) 205 depicted in FIG. 2, may encode a low-energy signal as a beacon probe request and broadcast the low-energy signal using a transceiver of a first device. The low-energy signal may be a Bluetooth® protocol or a Wi-Fi protocol, among other encoding schemes. In some example embodiments, the beacon probe may be associated with a rideshare application executing on the first device.

In step 510, the processor(s) 205 may determine a relative position of the first device with respect to two or more devices transmitting probe response signals associated with the beacon probe request. The processor(s) 205 may determine the relative position by receiving a first response signal having a first signal energy value, and a second response signal having a second signal energy value, and determining, based at least in part on the first response signal energy, a distance to a second device transmitting the first response signal. The processor(s) 205 may determine, based at least in part on the second response signal energy, a distance to a third device transmitting the second response signal.

At step 515, the processor(s) 205 may encode encoding one or more encrypted communication channels and establish an encrypted link with one or more of the first device and the second device. The secure link may be used, at least in part, for locating one or more of the first device or the responding device. Accordingly, locating the first device may include outputting an image indicative of a relative position of one or more of the second device and the third device on a user interface of the first device, wherein one or more of the second device and the third device are identified on the user interface with respect to the first device. In one embodiment, the first device may receive, via the encrypted communication channel, trip payment information indicative of an identity of one or more of a second device user and a third device user. When the user device determines that there is an active Internet communication channel connectable by the first device, the first device may transmit the trip payment information for payment of a rideshare.

This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below is presented for the purposes of illustration and is not intended to be exhaustive or to be limited to the precise form disclosed. Alternate implementations may be used in any combination desired to form additional hybrid implementations of the present disclosure.

Device characteristics described with respect to one feature of the present disclosure may provide similar functionality in other devices. For example, any of the functionality described with respect to a particular component such as a first processor in a first computer may be performed by another component such as a second processor in another computer. Further, although embodiments have been described in language specific to structural features and/or methodological acts, it is to be understood that the disclosure is not necessarily limited to the specific features or acts described.

In the above disclosure, reference is made to the accompanying drawings that illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described. Certain words and terms are used herein solely for convenience and such words and terms should be interpreted as referring to various objects and actions that are generally understood in various forms and equivalencies by persons of ordinary skill in the art.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not intended to imply that features, elements, and/or steps are in any way required for one or more embodiments.

It is anticipated and intended that future developments will occur in the technologies discussed herein, and that the disclosed systems and methods will be incorporated into such future embodiments. In sum, it should be understood that the application is capable of modification and variation.

That which is claimed is:

1. A method, comprising:
broadcasting, via a transceiver, an encoded low-energy signal comprising a beacon probe request associated with a rideshare application operative on a first device;
receiving a first probe response signal from a second device and a second probe response signal from a third device;
determining, based at least in part on the first probe response signal and the second probe response signal, a position of the first device with respect to the second device and the third device;
establishing an encrypted link with at least one of the second device and the third device; and
receiving, via one or more encrypted communication channels, user identification information associated with at least one of the second device and the third device, wherein the user identification information identifies a rideshare customer associated with the rideshare application.

2. The method according to claim 1, further comprising:
determining a first signal energy value associated with the first probe response signal;
determining a second signal energy value associated with the second probe response signal; and
determining, based at least in part on the first signal energy value and the second signal energy value, the position of the first device with respect to the second device and the third device.

3. The method according to claim 2, wherein determining the position of the first device further comprises:
determining a first Received Signal Strength Indicator (RSSI) value associated with the first signal energy value;
determining a second RSSI value associated with the second signal energy value;
determining, based at least in part on the first RSSI value and the second RSSI value, a path loss value; and
determining, based at least in part on the path loss value, the position of the first device respective to the second device and the third device.

4. The method according to claim 1, wherein the encoded low-energy signal comprises one of a Bluetooth® protocol and a Wi-Fi protocol.

5. The method according to claim 1, further comprising:
encoding an encrypted communication channel associated with the encrypted link, and
transmitting the position of the first device with respect to the second device and the third device based at least in part on a second device distance and a third device distance.

6. The method according to claim 1, further comprising:
generating an output, using a user interface, that indicates the position of the first device with respect to the second device and the third device.

7. The method according to claim 1, further comprising:
receiving, via an encrypted communication channel, trip payment information indicative of an identity of one or more of a first device user, a second device user, and a third device user;
determining that an active Internet communication channel is connectable by the first device; and
transmitting, based at least in part on determining that there is an active Internet communication channel, the trip payment information for payment of a rideshare.

8. A system comprising:
a processor; and
a computer-readable memory comprising program instructions that, when executed, cause the processor to:
broadcast, via a transceiver, an encoded low-energy signal comprising a beacon probe request associated with a rideshare application operative on a first device;
receive a first probe response signal from a second device and a second probe response signal from a third device;
determine, based at least in part on the first probe response signal and the second probe response signal, a position of the first device with respect to the second device and the third device;
establish an encrypted link with at least one of the second device and the third device; and
receive, via one or more encrypted communication channels, user identification information associated with at least one of the second device and the third device, wherein the user identification information identifies a rideshare customer associated with the rideshare application.

9. The system according to claim 8, wherein the processor is further configured to:
determine a first signal energy value associated with the first probe response signal;
determine a second signal energy value associated with the second probe response signal; and
determine, based at least in part on the first signal energy value and the second signal energy value, the position of the first device with respect to the second device and the third device.

10. The system according to claim 9, wherein the processor is further configured to:
determine a first Received Signal Strength Indicator (RSSI) value associated with the first signal energy value;
determine a second RSSI value associated with the second signal energy value;
determine a path loss value based at least in part on the first RSSI value and the second RSSI value; and
determine, based at least in part on the path loss value, the position of the first device respective to the second device and the third device.

11. The system according to claim 8, wherein the encoded low-energy signal comprises one of a Bluetooth® protocol and a Wi-Fi protocol.

12. The system according to claim 8, wherein the processor is further configured to:
encrypt a communication channel associated with the encrypted link; and
transmit the position of the first device with respect to the second device and the third device.

13. The system according to claim 8, wherein the processor is further configured to:
generate an output, using a user interface, that indicates the position of the first device with respect to the second device and the third device.

14. The system according to claim 8, wherein the processor is further configured to:
receive, via an encrypted communication channel, trip payment information indicative of an identity of one or more of a first device user, a second device user and a third device user;
determine that there is an active Internet communication channel connectable by the first device; and
transmit the trip payment information for payment of a rideshare.

15. A non-transitory computer readable medium comprising instructions executable to cause a processor to perform one or more acts comprising:
broadcasting, via a transceiver, an encoded low-energy signal comprising a beacon probe request associated with a rideshare application operative on a first device;
receiving a first probe response signal from a second device and a second probe response signal from a third device;
determining, based at least in part on the first probe response signal and the second probe response signal, a position of the first device with respect to the second device and the third device;
establishing an encrypted link with at least one of the second device and the third device; and
receiving, via one or more encrypted communication channels, user identification information associated with at least one of the second device and the third device wherein the user identification information identifies a rideshare customer associated with the rideshare application.

16. The non-transitory computer readable medium according to claim 15, wherein the one or more acts further comprise:
determining a first signal energy value associated with the first probe response signal;
determining a second signal energy value associated with the second probe response signal; and
determining, based at least in part on the first signal energy value and the second signal energy value, the position of the first device with respect to the second device and the third device.

17. The non-transitory computer readable medium according to claim 16, wherein the one or more acts further comprise:
determining a first Received Signal Strength Indicator (RSSI) value associated with the first signal energy value;
determining a second RSSI value associated with the second signal energy value;
determining a path loss value based at least in part on the first RSSI value and the second RSSI value; and
determining the position of the first device with respect to the second device and the third device using the path loss value.

18. The non-transitory computer readable medium according to claim 15, wherein the one or more acts further comprise:
encrypting the one or more encrypted communication channels, and
transmitting, based at least in part on a second device distance and a third device distance, the position of the first device with respect to the second device and the third device.

19. The non-transitory computer readable medium according to claim 15, wherein the one or more acts further comprise:
generating an output, using a user interface, that indicates the position of the first device with respect to the second device and the third device.

20. The non-transitory computer readable medium according to claim 15, wherein the one or more acts further comprise:
receiving trip payment information indicative of one or more user identities comprising an identity of a user of the first device, an identity of a user of the second device, or an identity of a user of the third device;
determining that there is an active network communication channel connectable by the first device; and
transmitting the trip payment information.
